(19) United States
(12) Patent Application Publication
(10) Pub. No.: US 2011/0136639 A1
(43) Pub. Date: Jun. 9, 2011

(54) DEVICE AND METHOD FOR PROCESSING OF FILM TUBES TO OPEN-MOUTHED BAGS AND FOR FILLING SAME WITH BULK MATERIALS

(75) Inventor: Thomas HILLING, Beckum (DE)

(73) Assignee: HAVER & BOECKER OHG, Oelde (DE)

(21) Appl. No.: 12/963,505

(22) Filed: Dec. 8, 2010

(30) Foreign Application Priority Data
Dec. 8, 2009 (DE) 10 2009 057 245.7

(51) Int. Cl. B31B 1/84

(52) U.S. Cl. 493/87

(57) ABSTRACT

Device and method for processing open-mouth bags with a bag opening device for opening an open-mouth bag and with a valve inserting device which is suitable and intended to insert a de-aeration valve into a bag wall of the open-mouth bag.

For filling bulk materials into bags, open-mouth bags are commonly used and so are valve bags provided with a filling valve attached on the side for filling bulk materials into bags. For filling, valve bags are placed onto a filling spout of a packaging machine. After discharge, the filling valve provides a certain mechanical protection against escape of filled bulk material. The manufacturing of valve bags in process within the packaging machine or in an immediately preceding device is virtually impossible though since valve bags are among other things folded over repeatedly during manufacture thus requiring multiple production steps which is not economical in the scope of a filling line.

Thus the present invention relates to a device and a method for processing open-mouth bags and for processing tubular material into open-mouth bags and in particular for subsequently filling the same with bulk materials.

Various devices and methods have become known in the prior art by means of which open-mouth bags are manufactured from tubular film which are subsequently filled with bulk material in the same device. These devices which form from tubular film, open-mouth bags or so-called open bags, subsequently filling these with bulk materials, tend to be called form-fill-seal machines (FFS machines).

FFS machines offer the advantage that the inexpensive starting material of tubular film can be processed as needed to open-mouth bags which are subsequently filled. The desired bag length can be quickly and easily adjusted to the product to be bagged and the quantity to be filled in. This provides substantial cost-effectiveness since the costs of the open-mouth bags contribute substantially to the variable costs in bagging bulk materials. When hundreds of thousands or millions of bags are filled per year, then considerable costs can be saved even if the bags employed are shorter only one percent or little more.

When filling bulk materials into bags, some air will as a rule also enter the bag. Air tends to be naturally present in bulk materials and it may even be added to the bulk materials to be bagged to obtain better free-flowing properties. When filling bulk materials into open-mouth bags, the bulk materials are typically fed into the open top end of the open-mouth bag by way of free fall. Although this realizes high-speed filling, considerable quantities of air will also enter the open-mouth bag. The large-size filling mouth extends across a considerable portion of the cross-section and depending on the bag construction it may comprise the entire cross-section of the open-mouth bag. After filling, the filling mouth needs to be closed for example in a welding process. However, air remaining in the open-mouth bag after closing results in poor stackability of the bags since they do not assume an optimal rectangular shape.

Therefore open bags or open-mouth bags have become known comprising de-aeration apertures to allow any air still present in the bag to escape after closing the open-mouth bag. A conceivable drawback of these de-aeration apertures is, however, that although waterproof tubular film is used as the open-mouth bag material, moisture may penetrate into the bag interior through the de-aeration apertures. For example cement filled into open-mouth bags as the bulk material will turn useless if moisture seeps in.

Furthermore, waterproof, pre-fabricated, plastic film open-mouth bags with incorporated de-aeration valves have become known. Their walls are provided with a de-aeration valve for excess air to escape. However, these open-mouth bags are closely correlated with the pricing policy and the capacities of the manufacturer. Also, the bag length cannot be variably adjusted during filling. Furthermore, rolling up pre-fabricated open-mouth bags is difficult because the inserted de-aeration valves produce awkward rolls.

Furthermore, EP 1 600 399 A1 discloses an open-mouth bag of a plastic film fillable with bulk material comprising a multi-layer overlapping region of an inner plastic layer and an outer plastic layer to prevent water from permeating into the finished open-mouth bag despite the de-aeration apertures provided. A first de-aeration aperture is provided in the inner plastic layer of the overlapping region and a second de-aeration aperture, in the outer plastic layer of the overlapping region. The first de-aeration aperture in the inner plastic layer and the second de-aeration aperture in the outer plastic layer are spaced apart from one another for example such that the inner de-aeration aperture in the inner plastic layer is provided centered on a side wall of the open-mouth bag while the outer de-aeration aperture in the outer de-aeration layer is provided in the region of the head or bottom seam. In this way such an open-mouth bag allows any air contained in the open-mouth bag to escape while concurrently, given suitable storage of the open-mouth bag, moisture is reliably prevented from seeping into the bag interior from the outside.

The known open-mouth bag involves the drawback of a relatively complex manufacture. The overlapping region with the inner de-aeration apertures is typically pre-fabricated such that the intended bag dimensions are fixedly predetermined and cannot be dynamically adjusted in the course of the packaging process. Also, the overlapping involves the drawback of increased film consumption which increases costs. Producing the open-mouth bags from tubular film in the machine itself is less expensive.

Furthermore, the complex manufacture causes relatively high prices for these open-mouth bags which results in corresponding costs for large production quantities.

In view of the indicated prior art it is therefore the object of the present invention to provide a device and a method for processing open-mouth bags wherein any air contained in the open-mouth bag can escape while the entry of water is inhibited.

This object is solved by a device having the features of claim 1. The method according to the invention is the subject of claim 14. Preferred embodiments are the subjects of the respective subclaims.

The device according to the invention for processing open-mouth bags comprises at least one bag opening device for opening an open-mouth bag. At least one valve inserting device is provided which is suitable and intended for inserting at least one de-aeration valve in at least one bag wall of the open-mouth bag.

The device according to the invention has many advantages. One considerable advantage of the device according to the invention is that the open-mouth bags can be equipped with one de-aeration valve or else multiple de-aeration valves so as to enable efficient de-aeration. The open-mouth bags may be pre-fabricated or else be manufactured in the device e.g. from tubular material immediately prior to filling. In all of the cases at least one de-aeration valve is inserted into the bag wall of the open-mouth bag at the device so as to provide a waterproof though air-permeable open-mouth bag.

Preferably the valve inserting device is equipped to enter into the opened open-mouth bag to there insert the at least one de-aeration valve into the bag wall.

Advantageously the valve inserting device is provided to be movable and in particular displaceable to enter into the opened open-mouth bag. It is also conceivable for the opened open-mouth bag to travel or to be pivoted to the valve inserting device for inserting the de-aeration valve into the bag wall. Particularly preferably the valve inserting device enters the opened open-mouth bag for placing the de-aeration valve in the bag wall from the inside.

In all of the configurations it is possible for the valve inserting device to be provided transverse to the open-mouth bag or laterally displaceable or adjustable so as to change and adjust the position of the de-aeration valves relative to the bag width. In particular does the de-aeration valve open when the pressure in the open-mouth bag interior is larger than external of the open-mouth bag. Preferably the de-aeration valve is provided with a filter or the like to allow the escape of air while fine-grain bulk materials are entirely or at least largely retained in the bag interior.

In particular can the de-aeration valve be configured substantially or entirely as a membrane. The material used is in particular semi-permeable.

Preferably the device is configured and equipped to manufacture open-mouth bags from tubular materials. To this end the device preferably comprises at least one tube stock with tubular materials and at least one bag forming device for manufacturing open-mouth bags from the tubular material. At least one bag forming device is provided comprising in particular at least one seam-producing device for producing a bottom seam and at least one cutting device for cutting a predetermined bag length off the tubular material.

A device so equipped has the additional advantage of allowing to form open-mouth bags of flexible lengths from the tubular material of the tube stock. In this way an open-mouth bag is provided which allows air to escape from its interior through the de-aeration valve while concurrently inhibiting or even preventing air or water or the like from entering from the exterior. While in storage the tubular film is not bulky because the de-aeration valves are not yet inserted. The costs may be kept down since manufacture may be simple and low-cost and the materials may be supplied from manufacturers not provided with their own valve inserting devices. Depending on the application, pre-fabricated open-mouth bags may be equipped with de-aeration valves or open-mouth bags are formed from tubular material into which de-aeration valves are inserted directly.

In particular is the tubular material impermeable to air or at least poorly permeable to air. The tubular material may be configured as a tubular film or at least comprise a tubular film. Or else, e.g. paper bags may be used as well.

According to a preferred more specific embodiment the device comprises at least one filling spout for filling the open-mouth bags in particular with bulk materials. The filling spout is in particular disposed downstream of the valve inserting device. Following the forming of the open-mouth bag from the tubular material and after inserting the de-aeration valve the open-mouth bags are attached to the filling spout where they are filled with the bulk material to be bagged.

To increase the de-aeration valve efficiency and to largely prevent clogging of the de-aeration valve by the bulk material to be filled into the open-mouth bag, the de-aeration valve is preferably inserted into the top end of the open-mouth bag and in particular is the de-aeration valve inserted in the vicinity of the intended head seam such that during filling the de-aeration valve comes into contact with the bulk material to be bagged as late as possible. In this way the de-aeration valve will be free of the bulk material to be bagged even after the filling process and thus any air contained in the open-mouth bag can readily escape outwardly.

Preferably at least one de-aeration valve is disposed on the inner wall of the open-mouth bag and inserted in the wall in particular from the inside. Then, increased internal pressure cannot cause the de-aeration valve to break off but rather ensures a still tighter seat of the de-aeration valve. The forming of a channel between the bag wall and the attached de-aeration valve can also be reliably prevented.

When inserting the de-aeration valve the bag wall is preferably punched in this place and a slit and in particular a cross-slit is made.

In the case of gusseted bags the de-aeration valve may be inserted in a gusset. The de-aeration valve or at least one de-aeration valve may also be inserted in the vicinity of the corner weld of the gusset.

Another considerable advantage of the device according to the invention is that the inserting of the de-aeration valves within the processing device for the tubular material allows place-saving and even storage of the tubular or film roll wound up in rolls. Namely, if the tubular material already comprised the de-aeration valves in periodic intervals then any tubular film rolled up on the tube stock would be bulky always in the same places where the de-aeration valve is inserted which would result in considerably smaller amounts of stock of the tubular material and also considerably poorer unrolling conditions of the tubular material from the tube stock. According to the invention, however, tubular material can be wound up on the tube stock without any problems. Optionally it is even possible to deactivate the valve inserting device in specific applications for example if de-aeration valves are not intended to be employed.

In all of the configurations the de-aeration valve is preferably configured water-impermeable and in particular air-permeable.

The de-aeration valve is in particular configured as a one-way valve and is inserted into the bag wall of the open-mouth bag so as to allow only substantially gaseous matter to escape from the interior of the open-mouth bag to the exterior while the de-aeration valve seals the bag wall in case that the exterior pressure is higher than in the interior.

Basically the de-aeration valve may be configured as these de-aeration valves are usually configured in the prior art. It is in particular essential for the entry of liquid water to be largely prohibited. It is also conceivable for the de-aeration valve to comprise or to be configured as at least an in particular microporous membrane. The de-aeration valve may in particular comprise a layered structure through which air can permeate while liquid water is retained. Among other things the use of ultrafine woven wire is also possible which is manufactured by applicant themselves in gas-permeable but watertight form.

In all of the configurations the tubular material preferably consists of at least one plastic film which is configured at least substantially watertight. The bag wall preferably consists substantially of at least one plastic film into which the de-aeration valve is inserted.

In advantageous more specific embodiments a closing device is provided for closing the open-mouth bag after filling with at least one head seam. The closing device may for example be configured as a welding device, forming a simple or double weld seam as the head seam.

To accelerate the escape of air still contained in the open-mouth bag at least one vibrating device may be provided which acts on the open-mouth bag prior to closing the open-mouth bag to accelerate de-aeration. Furthermore at least one squeezing device may be provided for squeezing out excess air which after closing the open-mouth bag with the head seam acts on the open-mouth bag to accelerate de-aeration of the open-mouth bag by artificially increasing the internal pressure.

In all of the configurations it is preferred for the length of an open-mouth bag produced in the bag forming device to be adjustable. The length may be changeable in particular in multiple steps or continuously or quasi continuously to allow optimal adjustment of the length to the prevailing conditions.

In particular the de-aeration performance of the de-aeration valve or the de-aeration valves is higher than 0.01 liters/minute on the whole, preferably the de-aeration performance is higher than 0.25 liters/minute and it may for example lie between 0.5 liters/minute and 20 liters/minute. Still higher de-aeration performances are possible given e.g. an excess pressure in the open-mouth bag of approximately 50 mbar.

In all of the configurations it is preferred for the de-aeration valve and in particular the active cross-sectional surface of the de-aeration valve to be smaller than 1% and preferably less than 0.5% and particularly preferably less than 0.1% of the entire bag wall surface. An open-mouth bag formed in this way enables cost-effective production since the open-mouth bag substantially only consists of low-cost tubular film while only a small surface is required for de-aeration.

The method according to the invention serves for processing open-mouth bags. A bag opening device opens an open-mouth bag at its top end and a valve inserting device inserts at least one de-aeration valve into the bag wall.

The method according to the invention also has many advantages. The method according to the invention allows flexible, simple, and low-cost production of an open-mouth bag wherein the open-mouth bag comprises a de-aeration function which by means of at least one de-aeration valve considerably reduces or entirely prevents permeation of for example moisture from the outside into the open-mouth bag.

Preferably the open-mouth bags are in particular produced immediately prior to inserting the de-aeration valve.

Tubular material is in particular used which is unwound from a tube stock and conveyed towards a bag forming device. In the bag forming device a bottom seam is made in the tubular material and a cutting device cuts off a predetermined length of bag. Then a bag opening device opens the open-mouth bag at its top end and preferably at least one valve inserting device enters the opened open-mouth bag and puts a de-aeration valve in the bag mouth.

The device according to the invention in particular serves particularly preferably for filling bags and it may comprise a tube stock and a bag forming device wherein at least one filling spout is provided for filling the bags and a bag closing device, for closing the bags. A bag forming device which may optionally be present comprises at least one seam-producing device for producing a bottom seam in the tubular material and at least one cutting device for cutting a predetermined bag length off the tubular material. A bag opening device serves for opening the open-mouth bag and at least one valve inserting device serves for inserting at least one de-aeration valve into the bag wall. The valve inserting device is in particular provided displaceable and it is preferably set up so as to enter into the open-mouth bag opened by the bag opening device to there insert at least one de-aeration valve into the bag wall.

Further advantages and features of the present invention ensue from the following embodiment which will now be described with reference to the enclosed figures.

The figures show in:

FIG. 1 a schematic illustration of the device of the invention in a first position;

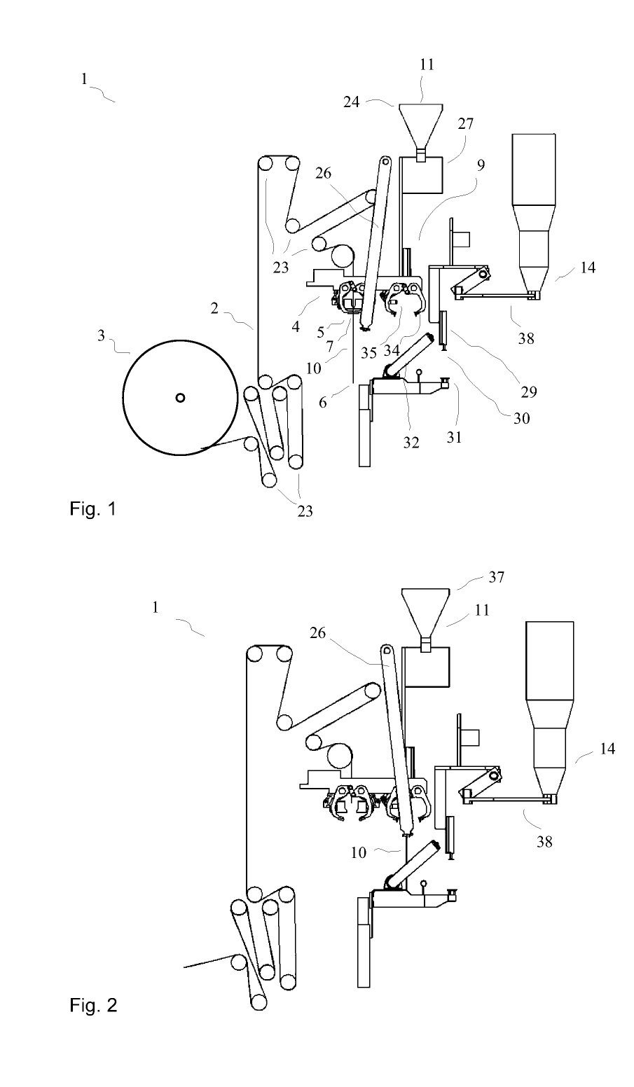

FIG. 2 a simplistic view of the device according to FIG. 1 in a second position;

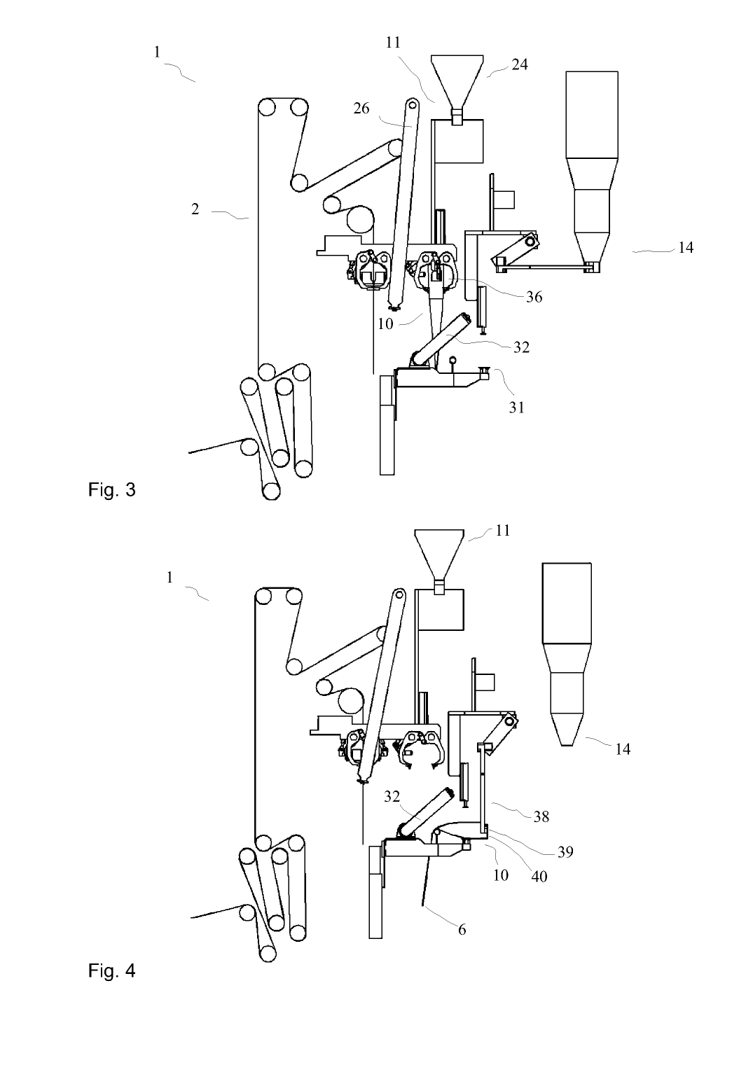

FIG. 3 a simplistic view of the device according to FIG. 1 in a third position;

FIG. 4 a simplistic view of the device according to FIG. 1 in a fourth position;

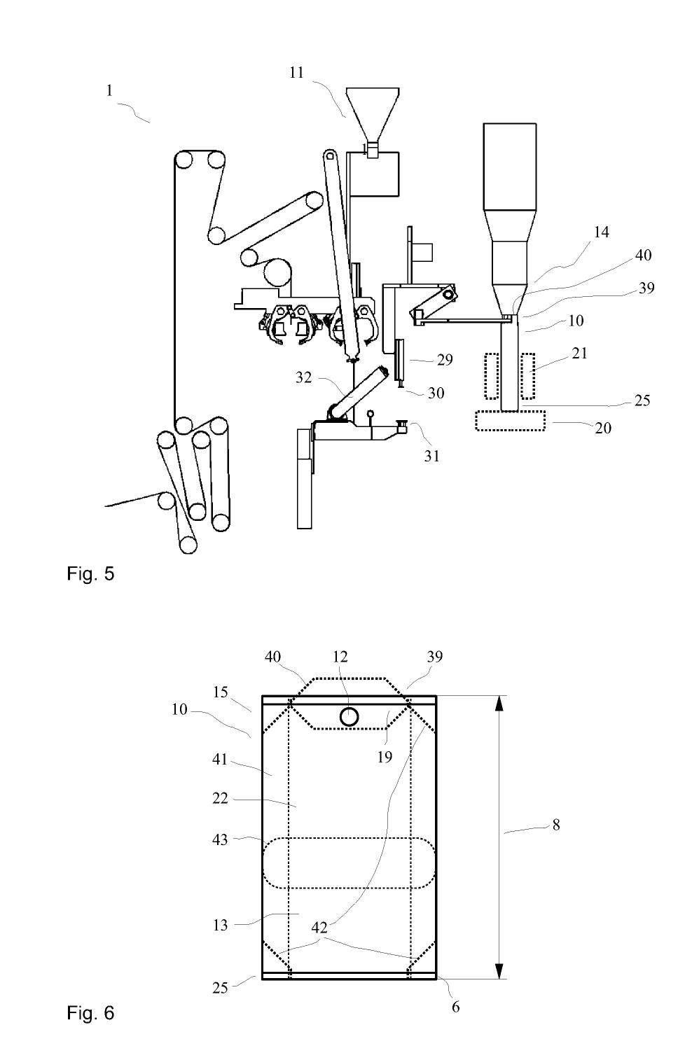

FIG. 5 a simplistic view of the device according to FIG. 1 in a fifth position; and

FIG. 6 a schematic view of an open-mouth bag filled by means of the device according to FIG. 1.

With reference to the enclosed FIGS. 1 to 6 an embodiment will now be explained of a device according to the invention for processing tubular material and in particular tubular film into open bags or open-mouth bags and for filling the same with bulk materials which inventive device 1 is presently configured as an FFS machine.

The FFS machine 1 illustrated in FIG. 1 in a schematic side view comprises a tube stock 3 on which the tubular film 2 is stocked wound-up. The fact that the tube stock 3 only stocks pure, wound-up tubular film, allows space-saving storage of the tubular film 2. Moreover, an even unwinding of the tube stock 3 off the roll can be ensured. This cannot be guaranteed in the case of previously inserted de-aeration valves which would make the tube roll bulky.

To allow the tubular film 2 to continuously roll off the tube stock 3 and to divert the tubular film 2 in the intended direction, multiple guide rollers 23 are provided which are optionally tightened over corresponding tightening devices for counter-balancing the indexed filling operation of the FFS machine 1.

The tubular film 2 is guided from the tube stock 3 via the guide rollers 23 to the bag forming device 4 where a seam-producing device 5 first makes a bottom seam 6 in the tubular film 2. Thereafter the tubular film 2 is conveyed further by a predetermined bag length 8 (see FIG. 6) and in the region of the top end 15 of the open-mouth bag 10 to be formed the floating gripper 26 seizes the tubular film 2. Thereafter the cutting device 7 separates the open-mouth bag 10 to be formed from the tubular film 2 so as to obtain a bag that is open on top or an open-mouth bag 10.

Subsequently the floating gripper 26 (see FIG. 2) displaces the open-mouth bag 10 to the valve inserting station 37. The valve inserting station 37 comprises a valve inserting device 11 and a valve store 24 in which de-aeration valves 12 to be inserted are stored. The de-aeration valves 12 are guided via the coil conveyer 27 out of the valve store 24 towards the inserting head 36 in a defined way.

At the valve inserting station 37 lever arms 34 of the bag opening device 9 provided with suction devices take over and hold the open-mouth bag 10. The floating gripper 26 releases the open-mouth bag 10 and returns to the position shown in FIG. 1.

Subsequently the lever arms 34 provided with suction devices of the bag opening device 9 open the top end 15 of the open-mouth bag 10 and the inserting head 36 of the valve inserting device 11 enters the interior of the open-mouth bag 10 from above. Prior to inserting the de-aeration valve 12 the bag wall is preferably die-punched and in particular a cross-slit is made in the bag wall.

Subsequently the inserting head 36 inserts a de-aeration valve 12 into the bag wall 13 from the inside. Then a back rest may generate the necessary back pressure from the outside.

Depending on the configuration of the de-aeration valve the de-aeration valve 12 is for example glued into the bag wall 13 or the de-aeration valve 12 may in particular be welded to the bag wall 13 by means of the welding device 35 to ensure a permanently tight seat of the de-aeration valve 12 in the bag wall 13. To this end, after inserting the de-aeration valve 12 into the bag wall 13 as shown in FIG. 3 the open-mouth bag 10 is taken over by the floating gripper 32 which has been displaced correspondingly and from there displaced further to the position illustrated in FIG. 4.

Thereafter the open bag or open-mouth bag 10 can be directly attached to a filling spout 14 of an FFS machine 1 and filled with bulk materials before a head seam 19 is made at the top end 15 of the open-mouth bag 10 by means of a seam-producing device 18 and the open-mouth bag 10 is thus closed.

In the presently illustrated embodiment the FFS machine 1 is configured so as to be compatible with a variant having no inserted de-aeration valves 12. To this end the valve inserting station 37 is deactivated and the open-mouth bag 10 is displaced to the position illustrated in FIG. 4 by means of the floating gripper 32.

In FIG. 4 the floating gripper 32 is shown in the neutral position again after depositing the open-mouth bag 10 horizontally flat on suction devices 31. Subsequently the cylinder 29 extends, bringing the suction device 30 into contact with the open-mouth bag 10 lying flat. The suction devices 30 or 31 seize the respective bag wall 13 and the cylinder 29 retracts back such that the top end 15 of the open-mouth bag 10 is opened.

Subsequently the bag placer 38 pivots into the open-mouth bag 10 opened at its top end 15, taking over the open-mouth bag 10 (see FIG. 4).

The open-mouth bag 10 seized by the bag placer 38 and presently configured as a flat bag can now pivot to the position illustrated in FIG. 5, placing the open-mouth bag 10 at the filling spout 14 with its filling end 39. There the open-mouth bag 10 is filled with the bulk material to be filled through the filling mouth 40 at the top filling end 39 presently extending across the entire width while the bottom end 25 with the bottom seam 6 hangs downwardly from the filling spout.

Following the filling operation a vibrating device 20 may cause a better and faster de-aeration of the open-mouth bag 10. After discharge of the open-mouth bag 10 and making a head seam 19 via another seam-producing device 5 a squeezing device 21 can apply pressure to the filled open-mouth bag 10 to achieve faster de-aeration. Therein the de-aeration valve 12 opens due to the excess pressure prevailing in the bag interior, allowing the contained air to escape while in the case of pressure applied from the outside the de-aeration valve 12 closes to prevent water or the like from permeating into the interior of the open-mouth bag. The squeezing device may in particular be located downstream of the packaging machine and disposed e.g. in the discharge line. The squeezing device may concurrently be employed for checking the leakproofness of the bag.

FIG. 6 shows a finished open-mouth bag 10 provided with an inserted de-aeration valve 12 at the top end 15 slightly beneath the head seam 19. The active cross-sectional surface of the de-aeration valve 12 in the present embodiment is less than approximately 0.1% of the bag surface. It is also conceivable for two or more de-aeration valves 12 to be inserted into the bag wall 13. The usual valve de-aeration performance is between approximately 0.1 and 10 liters/minute given an internal excess bag pressure of approximately 50 mbar.

The solid lines show a variant as a flat bag. Drawn in dashed lines is an additional variant of an open-mouth bag 10 provided with gussets 41. To this end the tubular film of the tubular material 2 may be provided with gussets 41. In the FFS machine 1 corner welds 42 may be inserted which in conjunction with the gussets 41 result in a rectangular structure of the finished, filled and closed open-mouth bags 10. The filling mouth 40 at the filling end 39 extends across the entire width between the gussets 41 or between the corner welds 42 and it may be configured for example hexagonal at a corresponding filling spout as it is shown in dashed lines in FIG. 6. After filling, a nearly rectangular cross-section 43 of the filled open-mouth bag 10 may ensue.

Via correspondingly controlling the advance rate and the cutting device 7 or the seam-producing device 5 for producing the bottom seam 6 the bag length 8 can be adjusted as desired. This allows to optimize the bag length 8 according to the specific application case which results in considerably savings of the bag material employed.

On the whole the invention provides a device 1 for processing tubular film 2 and a method for processing tubular film 2 and in particular for filling open-mouth bags 10 which allows to cost-efficiently and simply manufacture high quality open-mouth bags 10 from the tubular film 2 which bags can be flexibly adapted in length to the application.

The device 1 serves for processing tubular material 2 and in particular of tubular film. At least one tube stock 3 and at least one bag forming device 4 are provided for manufacturing open-mouth bags 10 from the tubular material 2. The bag forming device 4 comprises at least one seam-producing device 5 for producing a bottom seam 6 in the tubular material 2 and at least one cutting device 7 for cutting a predetermined bag length 8 off the tubular material 2. At least one bag opening device 9 is provided for opening the open-mouth bag 10. At least one valve inserting device 11 is provided for inserting at least one de-aeration valve 12 into the bag wall 13. The valve inserting device 11 can be provided movable and in particular displaceable and it is set up so as to enter into the open-mouth bag 10 which the bag opening device 9 has opened to there insert the at least one de-aeration valve 12 into the bag wall 13.

It is also conceivable to displace the open-mouth bag 10 to the valve inserting device 11 for inserting the de-aeration valve into the bag wall.

The valve inserting device 11 may also be provided to be displaceable or adjustable across the width of the open-mouth bags 10 to allow to freely select the position of the de-aeration valve 12.

Entering of the valve inserting device 11 into the open-mouth bag 10 may e.g. occur via an electric motor drive or via a hydraulic or pneumatic cylinder or a magnetic drive or the like.

Although the open-mouth bags 10 largely prevent water from entering, they allow escape of air from the open-mouth bag 10 interior to the outside. Depending on the structure of the de-aeration valve 12 a nearly watertight open-mouth bag 10 is possible. It is also possible for the de-aeration valve 12 to consist of a conventional de-aeration valve 12 and a water-impermeable but gas-permeable, semi-permeable membrane.

List of reference numerals:

| | |
|---|---|
| 1 | device |
| 2 | tubular film |
| 3 | tube stock |
| 4 | bag forming device |
| 5 | seam-producing device |
| 6 | bottom seam |
| 7 | cutting device |
| 8 | bag length |
| 9 | bag opening device |
| 10 | bag |
| 11 | valve inserting device |
| 12 | de-aeration valve |
| 13 | bag wall |
| 14 | filling spout |
| 15 | top end |
| 16 | membrane |
| 17 | plastic film |
| 18 | closing device |
| 19 | head seam |
| 20 | vibrating device |
| 21 | squeezing device |
| 22 | surface |
| 23 | guide roller |
| 24 | valve store |
| 25 | bottom end |
| 26 | floating gripper |
| 27 | coil conveyor |
| 29 | cylinder |
| 30 | suction device |
| 31 | suction device |
| 32 | floating gripper |
| 34 | lever arm |
| 35 | welding device |
| 36 | inserting head |
| 37 | valve inserting station |
| 38 | bag placer |
| 39 | filling end |
| 40 | filling mouth |
| 41 | gusset |
| 42 | corner weld seam |
| 43 | cross-section |

1. Device for processing open-mouth bags having at least one bag opening device for opening an open-mouth bag, characterized in that at least one valve inserting device is provided which is suitable and intended to insert at least one de-aeration valve into a bag wall of the open-mouth bag.

2. The device according to claim 1 wherein the valve inserting device is equipped to enter into the opened open-mouth bag to there insert the at least one de-aeration valve into the bag wall.

3. The device according to claim 1 wherein the valve inserting device is provided to be movable and in particular displaceable to enter the opened open-mouth bag.

4. The device according to claim 1 wherein the valve inserting device is provided to be displaceable transverse to the open-mouth bag.

5. The device according to claim 1 wherein at least one filling spout is provided for filling the open-mouth bags in particular with bulk materials which filling spout is disposed downstream of the valve inserting device.

6. The device according to claim 1 wherein the valve inserting device is suitable to insert the de-aeration valve at the top end of the open-mouth bag.

7. The device according to claim 1 wherein the de-aeration valve is configured water-impermeable and air-permeable.

8. The device according to claim 1 wherein the de-aeration valve comprises at least one membrane.

9. The device according to claim 1 wherein at least one tube stock with tubular material and at least one bag forming device are provided to manufacture open-mouth bags from the tubular material wherein the bag forming device comprises in particular at least one seam-producing device for producing a bottom seam and at least one cutting device for cutting off a predetermined bag length of the tubular material.

10. The device according to claim 1 wherein the bag wall comprises at least one plastic film into which the de-aeration valve is inserted.

11. The device according to claim 1 wherein a closing device is provided for closing the open-mouth bag after filling with at least one head seam.

12. The device according to claim 1 wherein the length of an open-mouth bag produced in a bag forming device is adjustable wherein the length is in particular variable in multiple steps or continuously.

13. The device according to claim 1 wherein the de-aeration valve is smaller than 1% and in particular smaller than 0.5% of the bag wall surface, and/or wherein the de-aeration performance is higher than 0.01 liters/minute and in particular higher than 0.25 liters/minute.

14. Method for processing open-mouth bags characterized in that the open-mouth bag is opened at its top end by means of a bag opening device and that a valve inserting device inserts at least one de-aeration valve into the bag wall.

15. The method according to claim 14 wherein the open-mouth bags are manufactured prior to inserting the de-aeration valve.
